(19) United States
(12) Patent Application Publication
(10) Pub. No.: US 2018/0357214 A1
(43) Pub. Date: Dec. 13, 2018

(54) LOG ANALYSIS SYSTEM, LOG ANALYSIS METHOD, AND STORAGE MEDIUM

(71) Applicant: NEC CORPORATION, Tokyo (JP)

(72) Inventor: Yasuhiro AJIRO, Tokyo (JP)

(73) Assignee: NEC CORPORATION, Tokyo (JP)

(21) Appl. No.: 15/775,489

(22) PCT Filed: Nov. 9, 2016
(86) PCT No.: PCT/JP2016/004843

§ 371 Date: May 11, 2018

(30) Foreign Application Priority Data
Nov. 13, 2015 (JP) 2015-223052

(51) Int. Cl. G06F 17/24; G06K 9/00; G06K 9/62; G06F 11/34

(52) U.S. Cl. CPC G06F 17/245; G06F 11/34; G06K 9/6215; G06K 9/00523

(57) ABSTRACT

Provided is a log analysis system, a log analysis method, and a storage medium that can efficiently identify a cause which leads to an anomaly. The log analysis system has a variable extraction unit that extracts, from a first log out of monitoring logs which does not match a format stored in a storage medium, a value of a variable included in the first log.

### TECHNICAL FIELD

The present invention relates to a log analysis system, a log analysis method, and a storage medium.

### BACKGROUND ART

In a system, a device, or the like, logs are generated in each of which the content of an event that occurred during operation, an operation status, or the like is recorded together with a date and time or the like. When an anomaly occurs in a system or the like, the cause of the anomaly is identified with analysis of the generated log.

Patent Literature 1 discloses an event log analysis device intended to support analysis of event logs performed by a manager. In an event log display window in the event analysis device disclosed in Patent Literature 1, event logs indicated in a log view are displayed in association with search conditions indicated in a search tree.

### CITATION LIST

### Patent Literature

PTL 1: Japanese Patent Application Publication No. 2005-141663

### SUMMARY OF INVENTION

### Technical Problem

In the event log analysis device disclosed in Patent Literature 1, however, there are disadvantages described below.

First, since a user is required to prepare, by itself in advance, a search condition for searching for event logs, it takes labor to create such a search condition. Further, it is unclear what search condition is required to be prepared for identifying the cause of an anomaly.

Further, in a search tree that displays a search condition set in hierarchical structure, it is unclear that a search result caused by a search condition originated from which node is to be prioritized and verified.

When a new log that does not match a format of a known log in a system or the like, that is, an abnormal log is generated, such a log indicates that an unknown event, that is, an anomaly has occurred. In the log analysis technology disclosed in Patent Literature 1, however, the disadvantages described above make it difficult to efficiently identify the cause which leads to an anomaly indicated by a new log.

The present invention has been made in view of the problems described above and intends to provide a log analysis system, a log analysis method, and a storage medium that can efficiently identify the cause which leads to an anomaly.

### Solution to Problem

According to an example aspect of the present invention, provided is a log analysis system comprising a variable extraction unit that extracts, from a first log out of monitoring logs which does not match a format stored in a storage medium, a value of a variable included in the first log.

According to another example aspect of the present invention, provided is a log analysis method comprising a step of extracting, from a first log out of monitoring logs which does not match a format stored in a storage medium, a value of a variable included in the first log.

According to yet another example aspect of the present invention, provided is a storage medium storing a program that causes a computer to perform a step of extracting, from a first log out of monitoring logs which does not match a format stored in a storage medium, a value of a variable included in the first log.

### Advantageous Effects of Invention

According to the present invention, it is possible to efficiently identify the cause which leads to an anomaly.

### BRIEF DESCRIPTION OF DRAWINGS

FIG. 1 is a schematic diagram illustrating a log analysis system and monitored systems, according to a first example embodiment of the present invention.

FIG. 2 is a block diagram illustrating a functional configuration of the log analysis system according to the first example embodiment of the present invention.

FIG. 3 is a block diagram illustrating an example of a hardware configuration of the log analysis system according to the first example embodiment of the present invention.

FIG. 4 is a diagram illustrating an example of clusters of logs obtained by clustering performed by a pattern extraction unit in the log analysis system according to the first example embodiment of the present invention.

FIG. 5 is a flowchart illustrating a log analysis method using the log analysis system according to the first example embodiment of the present invention.

FIG. 6 is a diagram illustrating an example of log patterns stored in a log pattern storage unit in the log analysis system according to the first example embodiment of the present invention.

FIG. 7 is a diagram illustrating an example of a table that records a result of inspection performed by a pattern inspection unit in the log analysis system according to the first example embodiment of the present invention.

FIG. 8 is a diagram illustrating an example of a variable value list stored in a variable value list storage unit in the log analysis system according to the first example embodiment of the present invention.

FIG. 9 is a diagram illustrating an example of search results by a search unit in the log analysis system according to the first example embodiment of the present invention.

FIG. 10 is a diagram illustrating an example in which search results are grouped by the search unit in the log analysis system according to the first example embodiment of the present invention.

FIG. 11 is a diagram illustrating another example in which search results are grouped by the search unit in the log analysis system according to the first example embodiment of the present invention.

FIG. 12 is a block diagram illustrating a functional configuration of a log analysis system according to a second example embodiment of the present invention.

FIG. 13 is a block diagram illustrating a functional configuration of a log analysis system according to a third example embodiment of the present invention.

FIG. 14 is a flowchart illustrating a log analysis method using the log analysis system according to the third example embodiment of the present invention.

FIG. 15 is a diagram illustrating a search condition setting window in the log analysis system according to the third example embodiment of the present invention.

FIG. 16 is a block diagram illustrating a functional configuration of a log analysis system according to a fourth example embodiment of the present invention.

FIG. 17 is a diagram illustrating extraction of a log pattern performed by a variable replacement unit in the log analysis system according to the fourth example embodiment of the present invention.

FIG. 18 is a diagram illustrating an example of a registration window for registering a log pattern in the log analysis system according to the fourth example embodiment of the present invention.

FIG. 19 is a diagram illustrating a functional configuration of a log analysis system according to a fifth example embodiment of the present invention.

FIG. 20 is a diagram illustrating an example of a setting window for setting whether or not log notification is necessary, in the log analysis system according to the fifth example embodiment of the present invention.

FIG. 21 is a block diagram illustrating a functional configuration of a log analysis system according to another example embodiment of the present invention.

FIG. 22 is a diagram illustrating a display example of search results by a search unit in a log analysis system according to a modified example embodiment of the present invention.

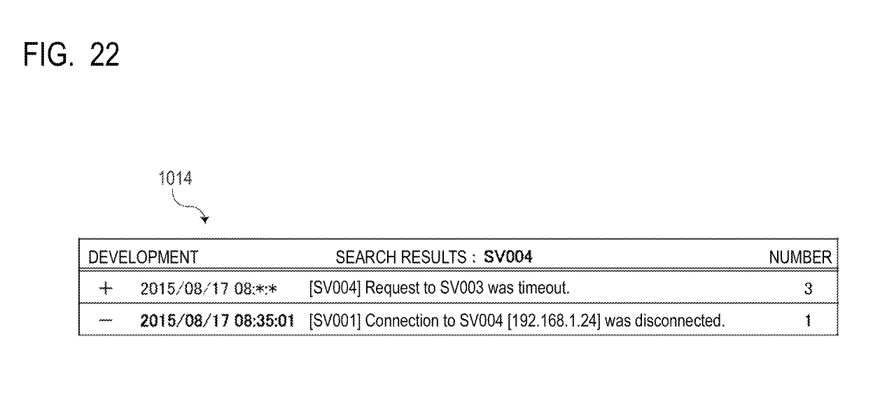

### DESCRIPTION OF EMBODIMENTS

### First Example Embodiment

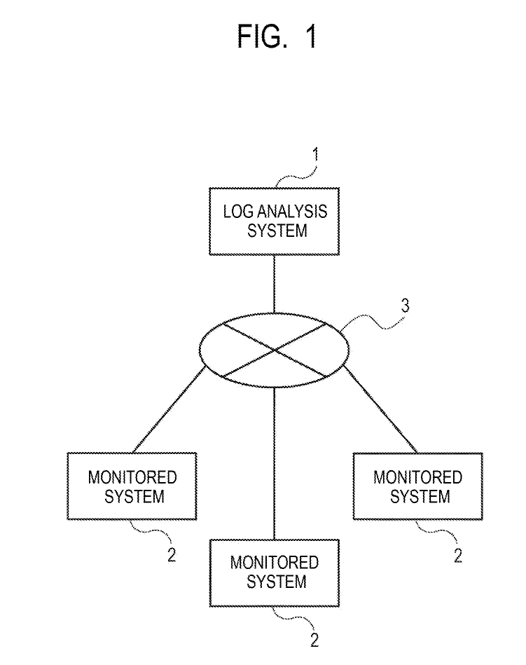

A log analysis system and a log analysis method according to a first example embodiment of the present invention will be described by using FIG. 1 to FIG. 10.

First, a general configuration including a log analysis system according to the present example embodiment and monitored systems to be monitored by the log analysis system will be described by using FIG. 1. FIG. 1 is a schematic diagram illustrating the log analysis system and the monitored systems according to the present example embodiment.

As illustrated in FIG. 1, to a log analysis system 1 according to the present example embodiment, one or a plurality of monitored systems 2 that generate and output logs to be analyzed by the log analysis system 1 are communicably connected via a network 3. While the network 3 is, for example, a Local Area Network (LAN) or a Wide Area Network (WAN), the type thereof is not limited. Further, the network 3 may be a wired network or may be a wireless network.

While not limited to a particular system, each of the monitored systems 2 may be an Information Technology (IT) system, for example. The IT system is formed of a device such as a server, a client terminal, a network device, or other information devices and software such as system software, application software, or the like running on the device. Each monitored system 2 generates a log that records the content of an event occurring during operation, a status during operation, or the like. Each log generated by the monitored system 2 becomes a monitoring log that is input to and analyzed by the log analysis system 1 according to the present example embodiment. Note that the log analysis system 1 according to the present example embodiment can monitor any system, device, or apparatus as long as it generates logs and can analyze logs generated by a monitored target.

A log generated by the monitored system 2 is input to the log analysis system 1 according to the present example embodiment via the network 3. The way of inputting a log to the log analysis system 1 from the monitored system 2 is not limited in particular and can be selected as appropriate in accordance with the configuration or the like of the monitored system 2.

For example, a notification agent in the monitored system 2 can transmit a log generated by the monitored system 2 to the log analysis system 1 to input the log to the log analysis system 1. The protocol for transmitting a log is not limited in particular and can be selected as appropriate in accordance with the configuration or the like of the system that generates a log. For example, a syslog protocol, a File Transfer Protocol (FTP), a File Transfer Protocol over Transport Layer Security (TLS)/Secure Sockets Layer (SSL) (FTPS), or a Secure Shell (SSH) File Transfer Protocol (SFTP) may be used as a protocol. Further, the monitored system 2 can share generated logs with the log analysis system 1 by using file sharing and thereby input the log to the log analysis system 1. The file sharing for sharing logs is not limited in particular and can be selected as appropriate in accordance with the configuration or the like of the system that generates a log. For example, file sharing by Server Message Block (SMB) or Common Internet File System (CIFS) that extends SMB can be used as file sharing.

Note that the log analysis system 1 according to the present example embodiment is not necessarily required to be communicably connected to the monitored systems 2 via the network 3. For example, the log analysis system 1 may be communicably connected to a log collecting system (not shown) that collects logs from the monitored systems 2 via the network 3. In this case, logs generated by the monitored systems 2 are temporarily collected by the log collecting system and then input to the log analysis system 1 from the log collecting system via the network 3.

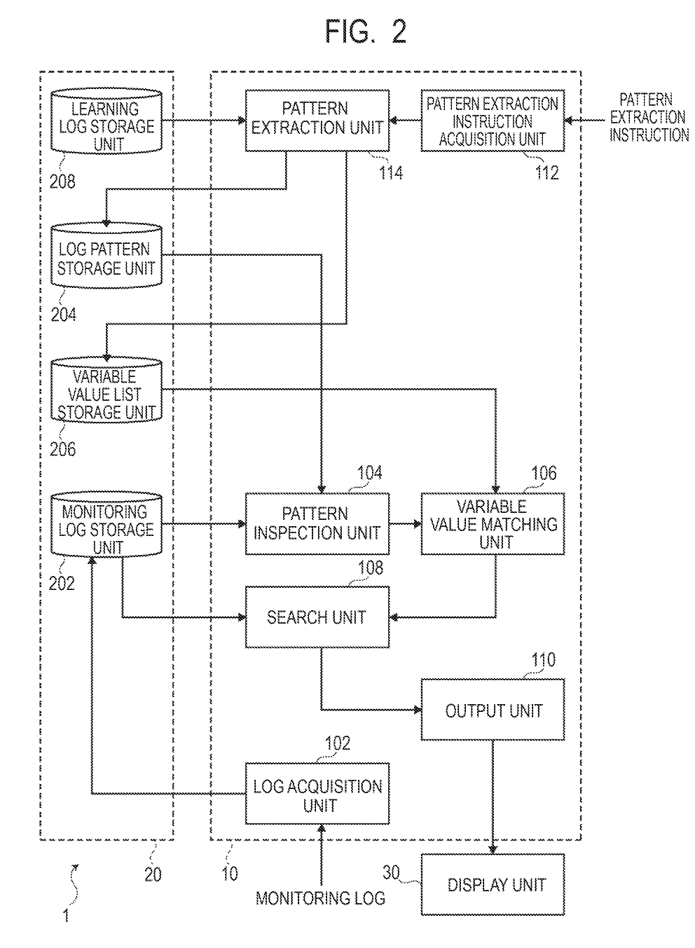

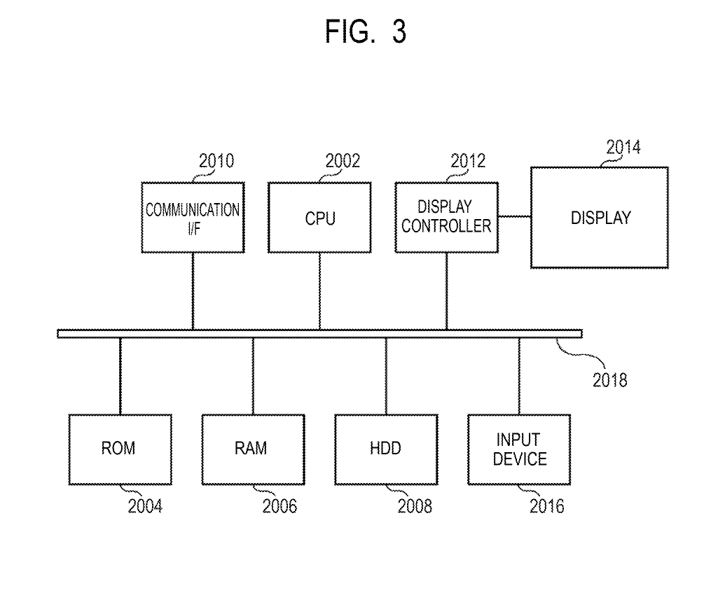

The specific configuration of the log analysis system 1 according to the present example embodiment will be further described below by using FIG. 2 and FIG. 3. FIG. 2 is a block diagram illustrating the functional configuration of the log analysis system according to the present example embodiment. FIG. 3 is a block diagram illustrating an example of the hardware configuration of the log analysis system according to the present example embodiment.

As illustrated in FIG. 2, the log analysis system according to the present example embodiment has a processing unit 10 that performs various processes for analyzing a log. Further, the log analysis system 1 has a storage unit 20 that stores monitoring logs and stores log patterns, a variable value list, and a learning log described later. Furthermore, the log analysis system 1 has a display unit 30 on which analysis results are output and displayed.

The processing unit 10 has a log acquisition unit 102, a pattern inspection unit 104, a variable value matching unit 106, a search unit 108, and an output unit 110. The processing unit 10 further has a pattern extraction instruction acquisition unit 112 and a pattern extraction unit 114.

The storage unit 20 has a monitoring log storage unit 202 that stores a monitoring log, a log pattern storage unit 204 that stores log patterns, a variable value list storage unit 206 that stores a variable value list, and a learning log storage unit 208 that stores a learning log. The storage unit 20 is formed of storage media, for example. Each unit of the storage unit 20 may be formed of the same storage media or may be formed of a plurality of storage media.

The display unit 30 displays a result of log analysis output from the processing unit 10. The display unit 30 is formed of an output device such as a display, a printer, or the like.

Logs to be monitored by the log analysis system 1 according to the present example embodiment are generated and output regularly or randomly from the monitored systems 2 or the components included therein. The log records the content of an event that has occurred during operation of the monitored systems 2 or the components included therein, a status during operation, or the like. For example, a log may be a message indicating an event that has occurred at a particular time or a status at a particular time. Further, a log may further include other information such as a timestamp indicating a generation time, the name of a component that has generated the log, or the like in addition to the content of an event or the like. Further, for example, a log is a row of or a plurality of rows of text data and may include one or more fields as a unit of information. A plurality of fields may be partitioned by one or more separators or delimiters or may be continuous without being partitioned. Continuous fields can be divided in terms of word, morpheme, character type, or the like.

The monitoring log storage unit 202 stores a monitoring log input to the log analysis system 1. Monitoring logs are input to the monitoring log storage unit 202 regularly or randomly or in real time, and the monitoring logs stored in the monitoring log storage unit 202 are additionally updated.

In a plurality of logs, there are logs having a common format pattern. Such a format pattern common to a plurality of logs is referred to as a log pattern. A log pattern having such a log format includes a common part that does not vary among the plurality of logs and a variable that is a part which can vary among the plurality of logs. For example, it is assumed that three logs: “Process p325 start”, “Process p223 start”, and “Process p234 start” are generated as logs. In this case, the common part common to the three logs is “Process” and “start”. On the other hand, the variable that is a part variable among the three logs corresponds to parts where “p325”, “p223”, and “p234” appear. The parts “p325”, “p223”, and “p234” are variable values that are values the variables may take. It is therefore estimated that the three logs have a common log pattern “Process <variable> start”. Note that a log pattern can be extracted from learning logs that are past logs described later.

The log pattern storage unit 204 stores log patterns as a database. Log patterns stored in the log pattern storage unit 204 are known log patterns. The log patterns stored in the log pattern storage unit 204 is referenced in analysis of a log generated in the monitored system 2.

Further, the variable value list storage unit 206 stores a variable value list that lists variable values that are values of variables in log patterns stored in the log pattern storage unit 204. The variable value list stored in the variable value list storage unit 206 is referenced in analysis of a log generated in the monitored system 2.

The log pattern stored in the log pattern storage unit 204 and the variable value list stored in the variable value list storage unit 206 described above are acquired by a pre-process prior to log analysis, respectively. The learning log storage unit 208 stores learning logs used for the pre-process performed for acquiring these log patterns and variable value list. The learning log may be some or all of the past logs generated by the monitored systems 2 or may be a log other than the logs generated by the monitored systems 2.

The log analysis system 1 according to the present example embodiment analyzes a monitoring log by using the log patterns and the variable value list described above. Respective units included in the processing unit 10 will be described below in detail.

The log acquisition unit 102 acquires a monitoring log input to the log analysis system 1 and stores the acquired monitoring log in the monitoring log storage unit 202 of the storage unit 20. Monitoring logs that are logs generated by the monitored system 2 are input to the log analysis system 1 regularly or randomly or in real time. The log acquisition unit 102 stores, in the monitoring log storage unit 202, the monitoring logs input in such a way.

The pattern inspection unit 104 inspects whether or not each log included in monitoring logs stored in the monitoring log storage unit 202 acquired by the log acquisition unit 102 match a known log pattern. The pattern inspection unit 104 compares a log included in monitoring logs with a log pattern stored in the log pattern storage unit 204, which is a known log pattern, and determines whether or not the log matches the known log pattern by using a scheme of pattern matching or the like, for example. Conceivable content of events or conceivable statuses are recorded in a log that matches any of the log patterns stored in the log pattern storage unit 204. On the other hand, a log that does not match any of the log patterns stored in the log pattern storage unit 204 is a new log, that is, an abnormal log. The new log indicates that an unknown event, that is, an anomaly occurs in the monitored system 2 that has generated the log. By determining whether or not each log included in monitoring logs matches a known log pattern in such a way, the pattern inspection unit 104 detects a new log indicating an anomaly from the monitoring logs.

The variable value matching unit 106 functions as a variable extraction unit and extracts a variable value from a new log detected by the pattern inspection unit 104. By matching a new log with a variable value included in the variable value list stored in the variable value list storage unit 206, the variable value matching unit 106 extracts a variable value from the new log.

The new log includes information that might have caused an anomaly indicated by the new log. The information that might have caused an anomaly often appears as a variable value in a log. For example, the name of a host computer that might have caused an anomaly may appear in a new log. As described above, by extracting a variable value from the new log using the variable value matching unit 106, it is possible to obtain the extracted variable value as information used for identifying the cause of an anomaly.

With respect to a new log, however, it is not possible to recognize a variable in the log based on a log pattern and extract the variable value thereof. Thus, the variable value matching unit 106 utilizes a variable value which is a variable value extracted in the past and included in the variable value list stored in the variable value list storage unit 206. With sufficient learning for acquiring the variable value list, the variable value that potentially appears in a new log is highly likely to be covered by the variable value list. For example, when the amount of learning logs used in the learning for acquiring the variable value list is sufficient, such a variable value is highly likely to be covered in the variable value list. Therefore, by matching a new log with a variable value included in the variable value list as described above, it is possible to extract a variable value from the new log.

Accordingly, in the present example embodiment, it is possible to obtain information for identifying the cause which leads to an anomaly by extracting a variable value from a new log using the variable value matching unit 106. According to the present example embodiment, since information for identifying the cause which leads to an anomaly is automatically acquired from the new log, this enables efficient identification of the cause which leads to an anomaly.

Note that, while the case where a variable value is extracted from a new log by using the variable value list has been described as an example, the way by which the variable value matching unit 106 extracts a variable value is not limited thereto. For example, the variable value matching unit 106 can use a variable pattern defined in normalized expression or the like to extract a variable value matching thereto from a new log. In this case, however, the variable pattern is required to be applicable to the new log.

The search unit 108 functions as a log output unit, which searches the monitoring logs stored in the monitoring log storage unit 202 for a log containing a variable value extracted by the variable value matching unit 106 and outputs the searched log. Logs searched by the search unit 108 includes a log indicating a process to an anomaly indicated by a new log. Therefore, with reference to information indicated by the logs searched by the search unit 108, it is possible to analyze a cause which leads to an anomaly indicated by a new log and identify the cause which leads to the anomaly.

An output unit 110 outputs search results from the search unit 108 to the display unit 30 and displays the search results on the display unit 30. The output unit 110 groups logs searched by the search unit 108 with respect to logs including the same variable value used for searching by the search unit 108 and displays the grouped logs on the display unit 30.

On the other hand, the pattern extraction instruction acquisition unit 112 and the pattern extraction unit 114 perform a pattern extraction process for acquiring a log pattern. The pattern extraction process has been performed in advance prior to log analysis. In the pattern extraction process, the variable value list is also acquired together with the log pattern.

The pattern extraction instruction acquisition unit 112 externally acquires a pattern extraction instruction that instructs execution of a pattern extraction process for acquiring a log pattern and inputs the pattern extraction instruction to the pattern extraction unit 114. The pattern extraction instruction can be externally input to the log analysis system 1 from an input device such as a keyboard, a touch panel, or the like, for example.

The pattern extraction unit 114 uses learning logs stored in the learning log storage unit 208 to perform a pattern extraction process for acquiring a log pattern. The pattern extraction unit 114 performs a pattern extraction process in accordance with a pattern extraction instruction input from the pattern extraction instruction acquisition unit 112. The pattern extraction unit 114 performs clustering with respect to a learning log described later to acquire a log pattern and acquire a variable value list. The pattern extraction unit 114 stores the acquired log pattern in the log pattern storage unit 204 and stores the acquired variable value list in the variable value list storage unit 206.

The log analysis system 1 described above is formed of a computer device, for example. An example of the hardware configuration of the log analysis system 1 will be described by using FIG. 3. Note that the log analysis system 1 may be formed of a single device or may be formed of two or more devices physically separated via wired or wireless connection.

As illustrated in FIG. 3, the log analysis system 1 has a central processing unit (CPU) 2002, a read only memory (ROM) 2004, a random access memory (RAM) 2006, and a hard disk drive (HDD) 2008. Further, the log analysis system 1 has a communication interface (I/F) 2010. Further, the log analysis system 1 has a display controller 2012 and a display 2014. Furthermore, the log analysis system 1 has an input device 2016. The CPU 2002, the ROM 2004, the RAM 2006, the HDD 2008, the communication I/F 2010, the display controller 2012, and the input device 2016 are connected to a common bus line 2018.

The CPU 2002 controls the entire operation of the log analysis system 1. Further, the CPU 2002 executes a program that implements the function of each of the log acquisition unit 102, the pattern inspection unit 104, the variable value matching unit 106, the search unit 108, the output unit 110, the pattern extraction instruction acquisition unit 112, and the pattern extraction unit 114 of the processing unit 10. The CPU 2002 loads, to the RAM 2006, and executes a program stored in the HDD 2008 or the like to implement the function of each unit of the processing unit 10.

Note that the log acquisition unit 102, the pattern inspection unit 104, the variable value matching unit 106, the search unit 108, the output unit 110, the pattern extraction instruction acquisition unit 112, and the pattern extraction unit 114 may be implemented by electric circuitry, respectively. Here, the electric circuitry is a term that conceptually includes a single device, multiple devices, a chipset, or a cloud.

The ROM 2004 stores programs such as a boot program. The RAM 2006 is used as a working area when the CPU 2002 executes a program. Further, the HDD 2008 stores programs executed by the CPU 2002.

Further, the HDD 2008 is a storage device that implements the function of each of the monitoring log storage unit 2002, the log pattern storage unit 2004, the variable value list storage unit 206, and the learning log storage unit 208 of the storage unit 20. Note that the storage device implementing the function of each unit of the storage unit 20 is not limited to the HDD 2008. Various storage devices may be used as those implement the function of each unit of the storage unit 20.

The communication I/F 2010 is connected to the network 3. The communication I/F 2010 controls data communication with the monitored system 2 connected to the network 3. The communication I/F 2010, together with the CPU 2002, implements a function of the log acquisition unit 102 of the processing unit 10.

The display controller 2012 is connected to the display 2014 that functions as the display unit 30. The display controller 2012, together with the CPU 2002, functions as the output unit 110 and displays a search result from the search unit 108 on the display 2014.

The input device 2016 is a keyboard, a mouse, or the like, for example. Further, the input device 2016 may be a touch panel embedded in the display 2014. Through the input device 2016, the operator of the log analysis system 1 is able to perform setting of the log analysis system 1 and input an instruction of execution of a process.

Note that the hardware configuration of the log analysis system 1 is not limited to the configuration described above and may take various configuration.

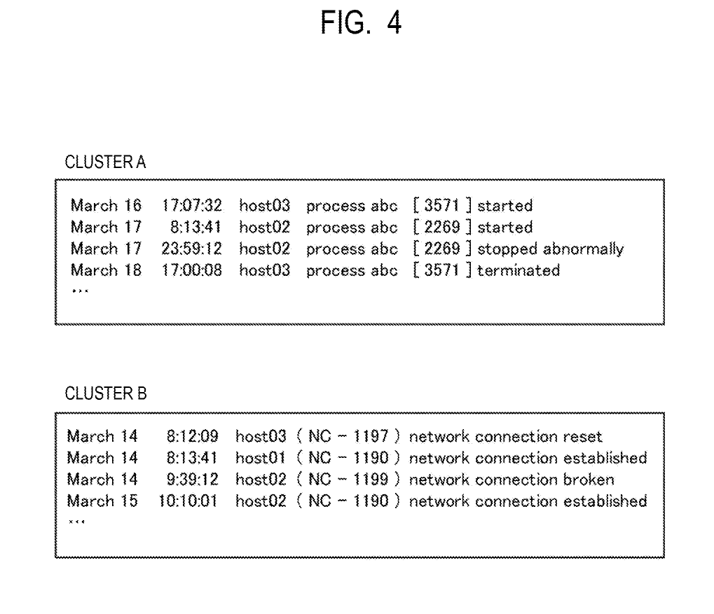

Next, a log analysis method using the log analysis system 1 according to the present example embodiment described above will be further described by using FIG. 4 to FIG. 10.

First, before the description of the log analysis method according to the present example embodiment, a process of acquiring a log pattern and a variable value list used for log analysis will be described by using FIG. 4. FIG. 4 is a diagram illustrating an example of clusters of logs obtained by clustering performed by the pattern extraction unit in the log analysis system according to the present example embodiment.

First, a pattern extraction instruction is input to the log analysis system 1 externally via the input device 2016 or the like. The pattern extraction instruction acquisition unit 112 acquires a pattern extraction instruction input to the log analysis system 1 and inputs the pattern extraction instruction to the pattern extraction unit 114.

The pattern extraction unit 114 performs a pattern extraction process in accordance with a pattern extraction instruction input from the pattern extraction instruction acquisition unit 112. In the pattern extraction process, the pattern extraction unit 114 performs clustering with respect to the learning logs stored in the learning log storage unit 208. Thereby, the pattern extraction unit 114 acquires a log pattern and acquires a variable value list.

In the clustering by the pattern extraction unit 114, logs included in the learning log are classified based on similarity among logs. More specifically, one log and another log whose similarity to the one log satisfies a predetermined condition are classified into the same cluster. The similarity of logs can be determined based on whether or not fields included in the logs are matched. Each of the fields included in the log may be partitioned by one or more separators or delimiters or may be continuous without being partitioned. In the case of continuous fields, however, a pre-process for separating the fields in terms of word, morpheme, character type, or the like will be necessary.

For example, the similarity between two logs can be determined in accordance with a similarity degree that is a value based on a ratio of the number of matching fields to the number of fields forming each log. In this case, the hither the similarity degree is, the higher the similarity between two logs is. For example, when each of two logs is formed of 10 fields and seven of which are matched, the similarity degree between these logs is calculated as 7/10=0.70. In this case, one log and another log whose similarity degree is above a threshold with respect to the one log can be classified into the same cluster.

Further, the similarity between two logs can be determined also in accordance with a distance that is a value based on the ratio of the number of not matching fields to the number of fields forming each log. In this case, the longer the distance is, the lower the similarity between the two logs is. For example, when each of two logs is formed of 10 fields and three of which are not matched, the distance between these logs is calculated as 3/10=0.3. In this case, one log and another log whose distance is below a threshold with respect to the one log can be classified into the same cluster.

Note that, when the number of fields is different between two logs, it is preferable to determine in advance to employ either one of the larger number of fields and the smaller number of fields as a denominator used in calculating the similarity degree or the distance.

Further, for fields which match a predetermined field pattern in each log, the similarity degree or the distance can be calculated under the assumption that these fields are the matching fields even though the values thereof are different. The predetermined field pattern is a pattern of values which may be taken by fields which can be assumed as a similar field even though the values thereof are different in a log. Such a field pattern may be defined in advance. Each log may include a timestamp indicating a date and time of generation of the log, such as “March 16, 17:07:32”, for example. Timestamps representing a date or a date and time or the like as above can be assumed as the similar field even when the values thereof are different.

Further, with respect to the number included in a log, the similarity degree or the distance can be calculated under the assumption that they are the matching fields even when the values thereof are different.

The pattern extraction unit 114 extracts and acquires a log pattern of logs included in a cluster for each cluster obtained by the clustering and extracts and acquires a variable value.

FIG. 4 illustrates clusters A and B as examples of clusters of logs obtained by clustering performed by the pattern extraction unit 114.

The log pattern included in the cluster A includes a common part of logs and variables included in the cluster A and is expressed as follows.

“<timestamp><variable: character string>process abc [<variable: number>]<variable: character string>*”
Note that “*” denotes any content, that is, represents that there are a case where a character string or a number appears in that field and a case where a character string or a number does not appear in that field.

Note that, although a timestamp can be handled as a variable, handling a timestamp as a variable is useless in identifying the cause of an anomaly. Thus, a timestamp may not be handled as a variable.

On the other hand, the log pattern of logs included in the cluster B includes a common part of logs and variables included in the cluster B and is expressed as follows.

“<timestamp><variable: character string>(NC—<variable: number>) network connection <variable: character string>”

A log pattern can be acquired, and variable values can be acquired, in a manner described above. A variable value list can be acquired by listing variable values. For example, “host03”, “host02”, “started”, “stopped”, “terminated”, and “abnormally” are obtained as variable values from logs included in the cluster A. Further, “host03”, “host01”, “host02”, “reset”, “established”, and “broken” are obtained as variable values from logs included in the cluster B. The variable value list can be acquired by listing variable values obtained in such a way.

Accordingly, the pattern extraction unit 114 stores the log pattern acquired by performing clustering in the log pattern storage unit 204 and stores the acquired variable value list in the variable value list storage unit 206.

Accordingly, log patterns and a variable value list used for log analysis are acquired.

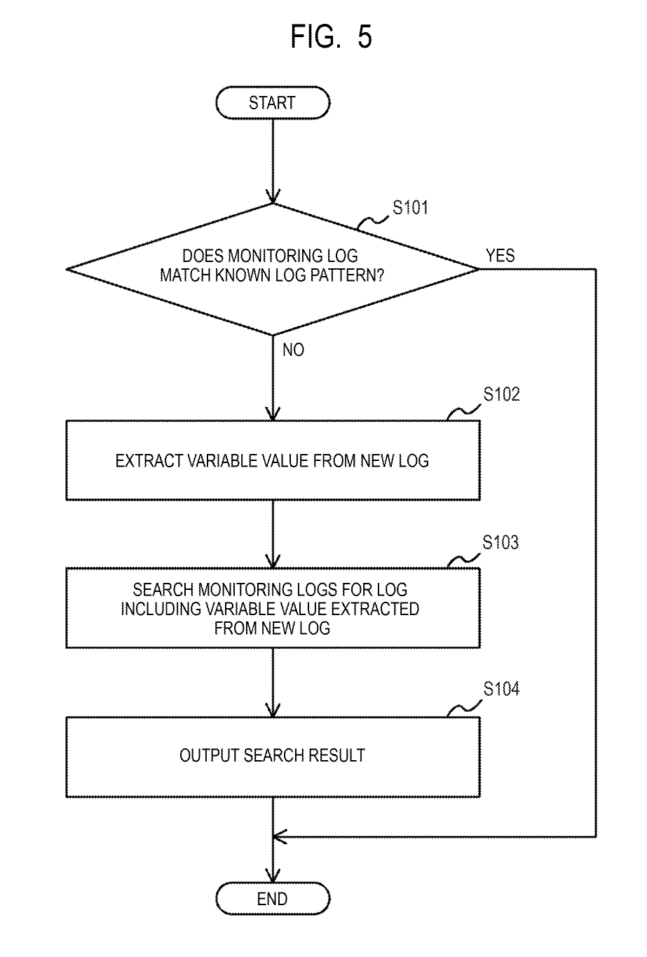

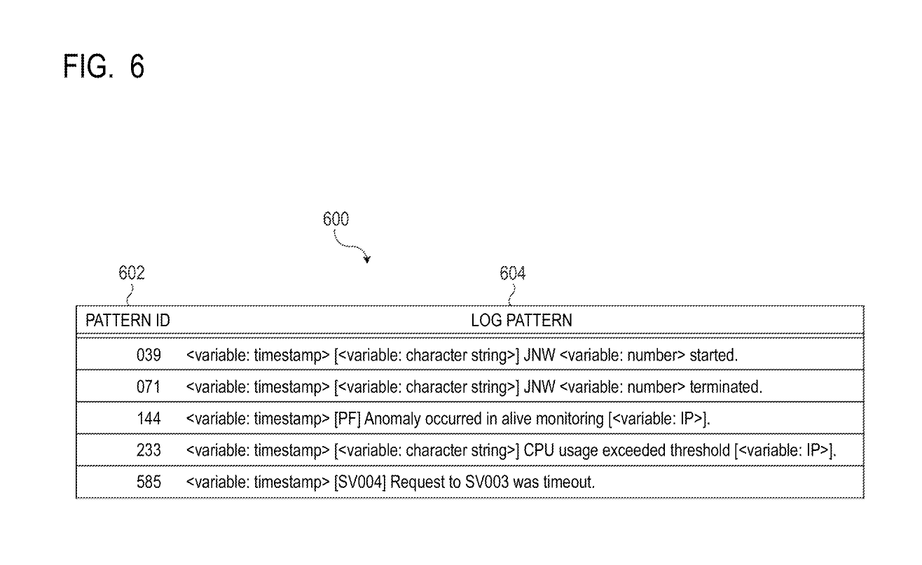

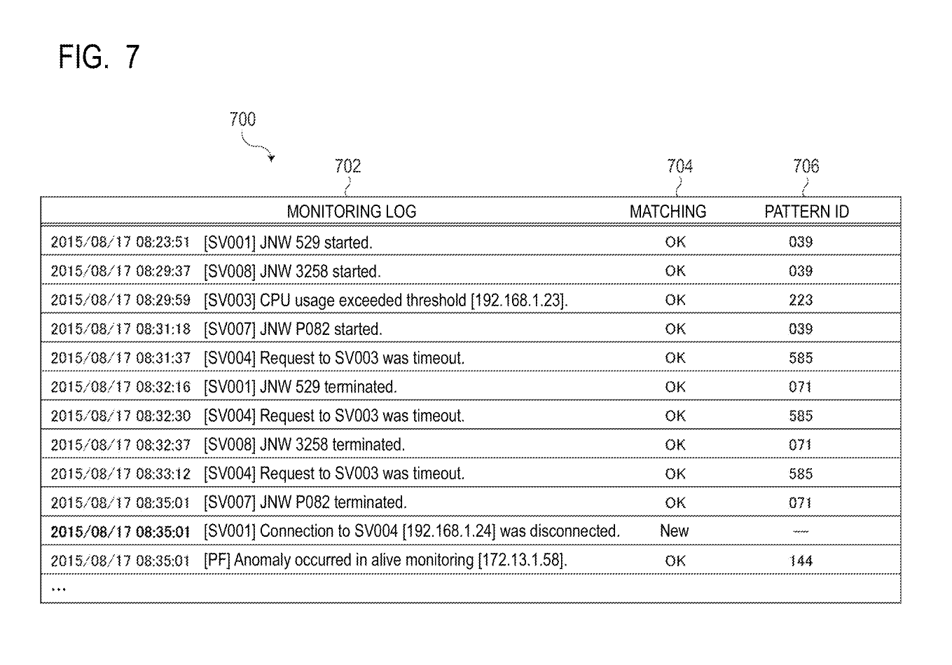

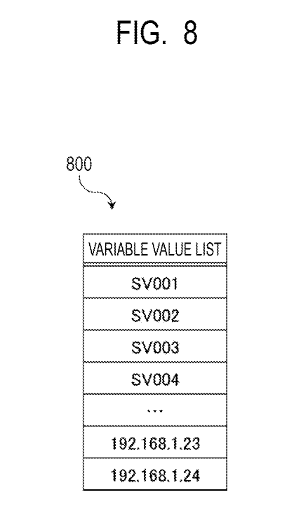

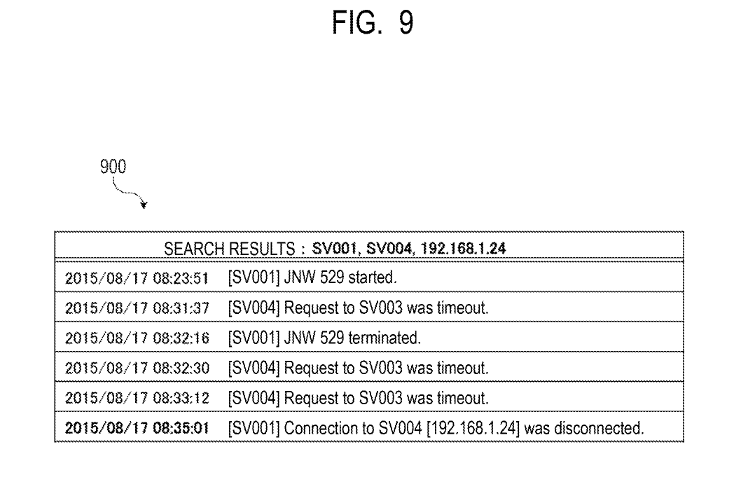

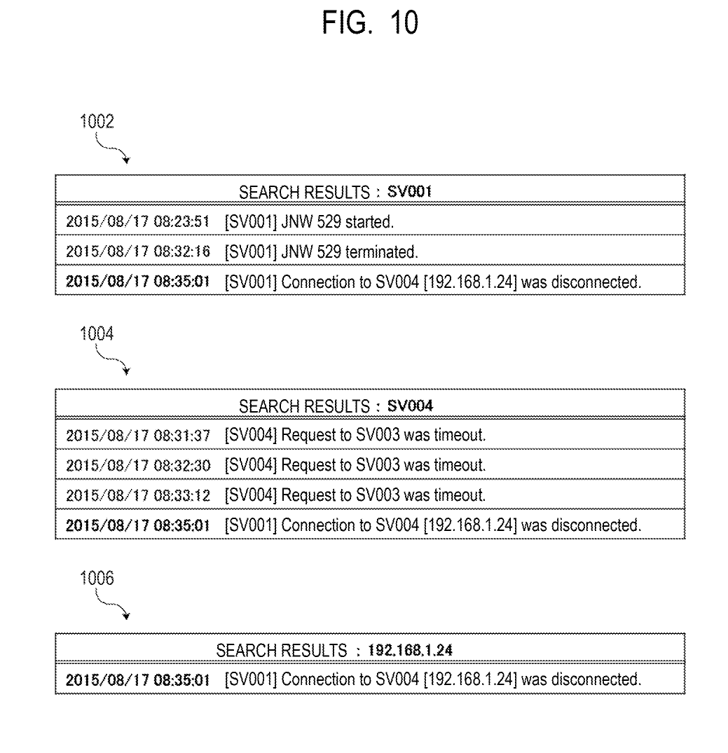

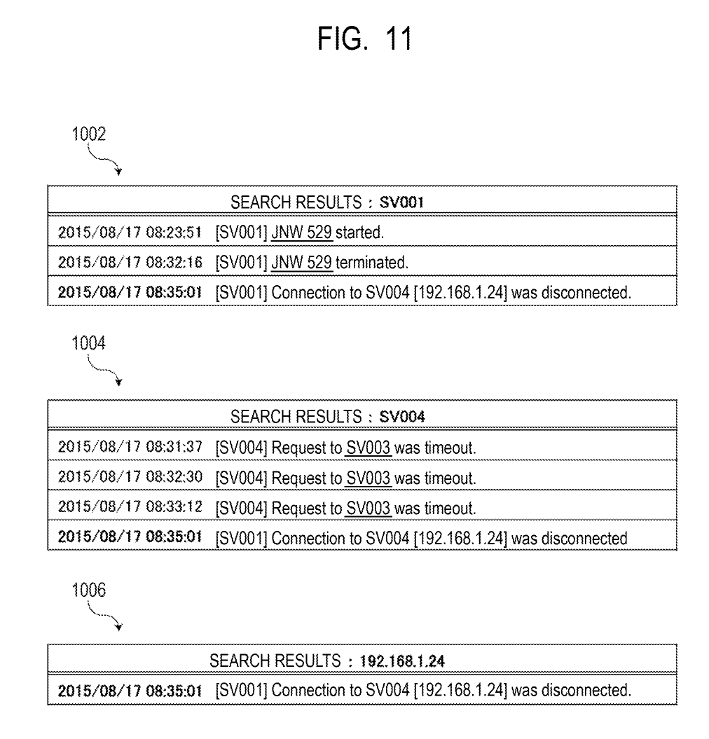

Next, a log analysis method by the present example embodiment using the log pattern and the variable value list acquired as described above will be described by using FIG. 5 to FIG. 11. FIG. 5 is a flowchart illustrating a log analysis method using the log analysis system according to the present example embodiment. FIG. 6 is a diagram illustrating an example of log patterns stored in the log pattern storage unit in the log analysis system according to the present example embodiment. FIG. 7 is a diagram illustrating an example of a table that records a result of inspection performed by the pattern inspection unit in the log analysis system according to the present example embodiment. FIG. 8 is a diagram illustrating an example of a variable value list stored in the variable value list storage unit in the log analysis system according to the present example embodiment. FIG. 9 is a diagram illustrating an example of search results by the search unit in the log analysis system according to the present example embodiment. FIG. 10 and FIG. 11 are diagrams each illustrating an example in which search results are grouped by the search unit in the log analysis system according to the present example embodiment.

Monitoring logs are input to the log analysis system 1 from the monitored system 2 regularly or randomly or in real time. The log acquisition unit 102 stores the monitoring log input to the log analysis system 1 in the monitoring log storage unit 202. Accordingly, the monitoring logs stored in the monitoring log storage unit 202 are additionally updated regularly or randomly or in real time.

The pattern inspection unit 104 inspects whether or not each of the monitoring logs stored in the monitoring log storage unit 202 matches a known log pattern (step S101). At this time, the pattern inspection unit 104 references log patterns stored in the log pattern storage unit 204 as known log patterns. The pattern inspection unit 104 then compares a monitoring log with log patterns stored in the log pattern storage unit 204 that are known log patterns and determines whether or not the monitoring log matches a known log pattern. A scheme of a pattern matching or the like can be used for the determination of matching, for example.

FIG. 6 is a diagram illustrating an example of a table that records known log patterns stored in the log pattern storage unit 204. Each record recorded in a table 600 illustrated in FIG. 6 has a pattern ID item 602 and a log pattern item 604. Pattern IDs for identifying log patterns are recorded in the pattern ID item 602. Log patterns are recorded in the log pattern item 604. In the example illustrated in FIG. 6, the variables are represented in a format of “<variable: XXX>”. Note that “XXX” denotes the content of a variable value. “XXX” in the example of FIG. 6 is any of “timestamp”, “character string”, “number”, and “IP”, and the content of the variable values represents a timestamp, a character string, a number, and an Internet Protocol (IP) address, respectively.

FIG. 7 is a diagram illustrating an example of a table that records a result of inspection performed by the pattern inspection unit 104 using the known log pattern illustrated in FIG. 6. A table 700 recording a result of inspection is stored in the storage unit 20, for example. Each record recorded in the table 700 illustrated in FIG. 7 has a monitoring log item 702, a matching item 704, and a pattern ID item 706. The inspected monitoring logs are recorded in the monitoring log item 702. Results of inspection are recorded in the matching item 704. When the matching item 704 is “OK”, this indicates that the monitoring log matches a known log pattern, and when the matching item 704 is “New”, this indicates that the monitoring log is a new log that does not match any known log. Pattern IDs of log patterns are recorded in the pattern ID item 706 each of which is matched by a monitoring log when the monitoring log matches a known log pattern.

Note that the pattern inspection unit 104 can display the inspection result on the display unit 30 in a form such as the table 700 illustrated in FIG. 7. In the display of the inspection result on the display unit 30, a new log of the inspected monitoring logs can be displayed with highlighting, for example. A form of highlighting display of a new log is not limited in particular, and various display can be used, such as display in a different color from other part, display in a different font, display in bold characters, or the like.

If a monitoring log matches a known log pattern (step S101, YES), conceivable content of an event or a conceivable status is recorded in the monitoring log. The process then ends, because no particular action is required to be taken for an event or a status indicated in a monitoring log which matches a known log pattern.

Note that some action can be taken for an event or a status indicated in the monitoring log which matches a particular log pattern. In this case, an action defined in advance may be presented to the operator, who is a user of the log analysis system 1, in accordance with a pattern ID of a log pattern that the monitoring log matches.

On the other hand, if a monitoring log does not match any of the known log patterns (step S101, NO), the monitoring log is a new log, that is, an abnormal log. The new log indicates that an unknown event, that is, an anomaly occurs in the monitored system 2 that has generated the log. It is therefore necessary to take some action to the event or the status indicated in the new log.

In the example illustrated in FIG. 7 described above, a monitoring log generated at a date and time indicated by a timestamp “2015/08/17 08:35:01” is detected as a new log as a result of inspection performed by the pattern inspection unit 104. The monitoring log detected as the new log dose not match any of the log patterns illustrated in FIG. 6.

While the content of a new log does not match a known log pattern, it is necessary to read and analyze the content thereof in order to identify a cause of an anomaly. With respect to a log format, while there is no defined rule or the like that defines information to be included in a log or the like, there is common knowledge of including an output source that has generated a timestamp or a log or the like. With a use of such common knowledge of log formats or knowledge of information technologies, the content of a new log can be read.

For example, from a monitoring log detected as a new log in FIG. 7, it can be read that it has been generated and output from an output source of “SV001” that is a host computer. It can be further read that network connection to “SV004” that is a host computer has been disconnected. Furthermore, it can be read that “192.168.1.24” is an IP address, which is the IP address of “SV004”.

In a new log, information that could be a cause which leads to an anomaly indicated by the new log may often appear as a variable value in the log. Thus, the variable value matching unit 106 extracts the variable value from the new log detected by the pattern inspection unit 104 (step S102). In the extraction of the variable value, the variable value matching unit 106 performs matching of the new log with variable values included in the variable value list stored in the variable value list storage unit 206.

FIG. 8 is a diagram illustrating an example of a variable value list. A variable value list 800 illustrated in FIG. 8 is acquired together when the log pattern illustrated in FIG. 6 is acquired. The variable value list 800 includes “SV001”, “SV002”, “SV003, and “SV004” as variable values indicating hosts and includes “192.168.1.23” and “192.168.1.24” as variable values indicating IP addresses.

With respect to a new log, it is not possible to recognize a variable value in the log based on the log patterns to extract the variable value. Thus, as described above, the variable value matching unit 106 utilizes variable values, which are the variable values extracted in the past, included in the variable value list stored in the variable value list storage unit 206. The variable value matching unit 106 can extract variable values from a new log by performing matching of the new log with variable values included in the variable value list. Note that it is also possible to use a variable pattern defined in normalized expression or the like to extract a variable value matching thereto from a new log as described above.

For example, in the case of a new log detected in FIG. 7, “SV001”, “SV004”, and “192.168.1.24” are extracted as variable values through matching using the variable value list illustrated in FIG. 8.

The variable value extracted by the variable value matching unit 106 can be displayed with highlighting in the display of the new log on the display unit 30. A form of highlighting display of a variable value is not limited in particular, and various display can be used such as display in a different color from other part, display in a different font, display in bold characters, or the like.

As discussed above, according to the present example embodiment, information for identifying a cause which leads to an anomaly can be obtained by extracting a variable value from the new log by the variable value matching unit 106. The extracted variable value can be displayed on the display unit 30 by using the output unit 110, which is assumed to indicate information used for identifying the cause which leads to an anomaly. Analysis of the variable value obtained as the information for identifying the cause which leads to an anomaly enables identification of the cause which leads to the anomaly. In order to identify the cause which leads to an anomaly, the components of the monitored system 2 indicated in the extracted variable value may be verified, for example. Further, in the present example embodiment, in order to identify the cause which leads to an anomaly, a log including the extracted variable value can be searched as described later.

Furthermore, by performing an operation of analyzing past logs including variable value appearing in the new log out of the monitoring log to review the past, it is possible to refine and identify the cause of an anomaly indicated in the new log. In the case of the new log detected in FIG. 7, “SV001”, “SV004”, and “192.168.1.24” are extracted as variable values. In this case, the cause of network disconnection recorded in the new log may be in “SV001” that is the output source thereof or may be in a host or software residing in “SV004” or the post-stage of “SV004”. In the present example embodiment, as described below, searching for the past log including variable values appearing in a new log by the search unit 108 allows for refining and identifying the cause of an anomaly.

After the variable value is extracted from the new log, the search unit 108 searches the monitoring log stored in the monitoring log storage unit 202 for a log including variable value extracted by the variable value matching unit 106 (step S103). The searched log includes a log indicating a process to an anomaly as described above. Therefore, in the present example embodiment, with reference to information indicated in a log searched by the search unit 108, it is possible analyze and identify the cause of an anomaly indicated by a new log.

FIG. 9 is a diagram illustrating an example of search results obtained by the search unit 108. Specifically, FIG. 9 illustrates results of searching for logs including “SV001”, “SV004”, and “192.168.1.24” that are variable values extracted by the matching using the variable value list illustrated in FIG. 8. A log list 900 that corresponds to search results illustrated in FIG. 9 includes logs which include at least any one of “SV001”, “SV004”, and “192.168.1.24” out of the monitoring log. The log list 900 also includes the new log detected in FIG. 7.

Note that the search unit 108 can limit the time range of logs to be searched to a certain time range. For example, the time range of logs to be searched may be limited to a predetermined range such as, for example, within one hour before the occurrence of a new log, within a range from the first time to the second time, or the like. The time range of logs to be searched by the search unit 108 can be properly set by the operator.

Next, the output unit 110 outputs the search results obtained by the search unit 108 to the display unit 30 and displays them on the display unit 30 (step S104). At this time, the output unit 110 can group the logs searched by the search unit 108 into a group of logs including the same variable value as used in the searching by the search unit 108 and display the group on the display unit 30.

FIG. 10 is a diagram illustrating an example in which search results obtained by the search unit 108 are grouped and displayed. Specifically, FIG. 10 illustrates a plurality of log lists obtained by grouping the results illustrated in FIG. 9. FIG. 10 illustrates a plurality of log lists 1002, 1004, and 1006. In the log list 1002, logs including “SV001” are grouped out of the searched variable values. In the log list 1004, logs including “SV004” are grouped out of the searched variable values. In the log list 1006, a log including “192.168.1.24” is grouped out of the searched variable values. The output unit 110 can group one or more logs including the same variable value into a plurality of log lists in such a way and display them on the display unit 30.

Note that, when a plurality of variable values are extracted by the variable value matching unit 106 as described above, the plurality of variable values can be prioritized, and the display order of the log lists that has been grouped on a variable value basis can be set in accordance with the priority. In general, such a variable value that appears at the closest position to the head of a log, for example, a variable value in the header of a log may be a typical value and often unrelated to an anomaly. Thus, for example, with respect to the priority of the variable value, a higher priority may be provided to such a variable value that appears at a position closer to the tail of a log. Further, a higher priority may be provided to a rare variable value that less frequently appears. Then, when a plurality of log lists are displayed, a log list in which one or more logs including variable values having a higher priority are grouped may be displayed with a higher priority on the display unit 30.

From the grouped search results illustrated in FIG. 10, it can be seen that “SV004” appearing as a variable value in the new log detected in FIG. 7 generates multiple times of timeout for a request to “SV003”. Thus, it can be seen that there is a high likelihood that the cause of the anomaly indicated in a new log is in the communication status of “SV004”.

Note that, in the logs searched when logs including a variable value included in a new log are searched by the search unit 108, information which may be a cause of an anomaly indicated in the new log may appear as a variable value in the log. For example, when “SV004” generates multiple times of timeout for a request to “SV003” as described above, not a little likelihood of an anomaly being caused by “SV003” remains. Thus, the search unit 108 can be configured to search for a log including a variable value included in a new log and then, out of the monitoring log, further search for a log including a variable value included in the log searched in the searching. Thereby, the cause which leads to an anomaly can be identified with high accuracy.

In this case, the search unit 108 can be configured to display a variable value included in a log in a clickable form and, in response to a click on the variable value, perform search for a log including the variable value in the log list displayed on the display unit 30. Note that, in this searching, the search unit 108 can search for and output a log including at least the variable value and can search for and output a log including the variable value and another variable value. This search result can be displayed on the display unit 30 by the output unit 110.

FIG. 11 is a diagram illustrating another example in which search results obtained by the search unit 108 is grouped and displayed. FIG. 11 illustrates a case where the variable values included in the logs in the log list illustrated in FIG. 10 are displayed in a clickable form. Specifically, “JNW 529”, which is a variable value included in the log of the log list 1002, is displayed with highlighting by an underline, for example, and thereby configured to be clickable. Once “JNW 529” is clicked on the display window, the search unit 108 performs searching that searches a monitoring log for a log including “JNW 529”. Also, “SV003”, which is a variable value included in the log of the log list 1004, is displayed with highlighting by an underline, for example, and thereby configured to be clickable. Once “SV003” is clicked on the display window, searching that searches a monitoring log for a log including “SV003” is searched by the search unit 108. Note that a form of highlighting display of a variable value indicative of being searchable is not limited in particular, and various display can be used such as display in a different color from other part, display in a different font, display in bold characters, or the like other than highlighting display.

As discussed above, according to the present example embodiment, the cause which leads to an anomaly indicated in a new log can be efficiently identified based on a search result obtained by the search unit 108 displayed on the display unit 30.

### Second Example Embodiment

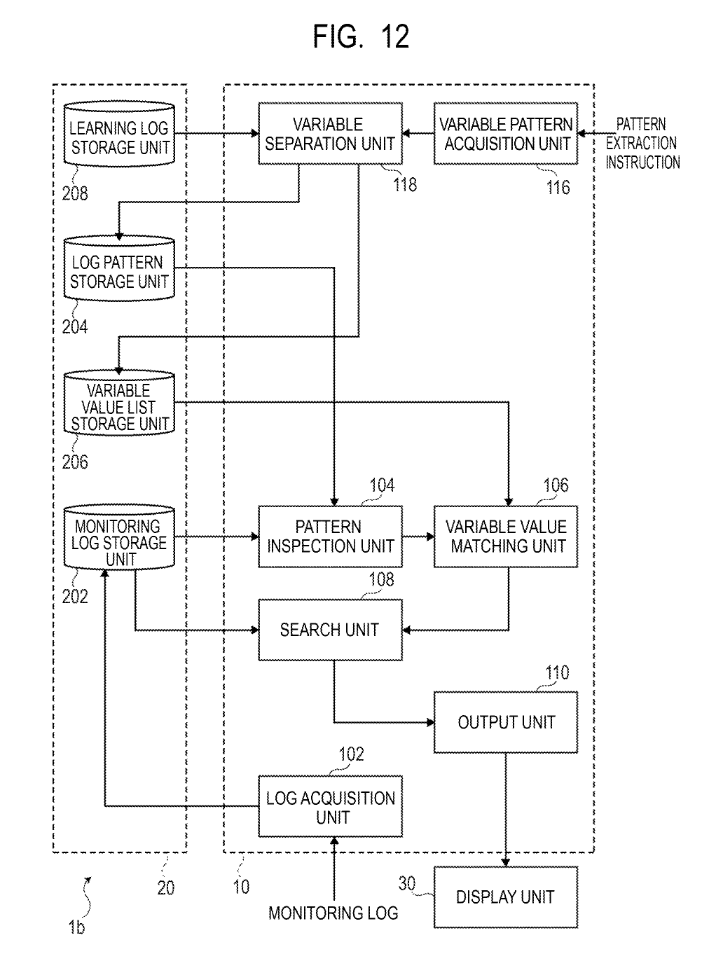

A log analysis system and a log analysis method according to a second example embodiment of the present invention will be described by using FIG. 12. FIG. 12 is a schematic diagram illustrating a functional configuration of the log analysis system according to the present example embodiment. Note that components similar to the log analysis system and the log analysis method according to the first example embodiment described above are labeled with the same reference symbol, and the description thereof will be omitted or simplified.

The log analysis system 1 according to the first example embodiment described above acquires a log pattern and a variable value list by clustering performed by the pattern extraction unit 114. In contrast, the log analysis system according to the present example embodiment is different from the log analysis system 1 according to the first example embodiment in that a variable pattern is used to acquire a log pattern and acquire a variable value list.

As illustrated in FIG. 11, a log analysis system 1b according to the present example embodiment has a variable pattern acquisition unit 116 and a variable separation unit 118 instead of the pattern extraction instruction acquisition unit 112 and the pattern extraction unit 114 in the processing unit 10.

The variable pattern acquisition unit 116 acquires a variable pattern externally input to the log analysis system 1b. A variable pattern is defined in normalized expression or the like by the operator or the like. For example, when a number is handled as a variable, a variable pattern can be defined in normalized expression such as “[0-9]+”. The variable pattern acquisition unit 116 inputs the acquired variable pattern to the variable separation unit 118.

The variable separation unit 118 recognizes and separates a variable value in a log based on a variable pattern input from the variable pattern acquisition unit 116 for each of the learning logs stored in the learning log storage unit 208. By separating a variable value in a log in such a way, the variable separate unit 118 acquires a log pattern and acquires a variable value list.

Note that the log analysis system 1b according to the present example embodiment may also have the same hardware configuration as that in the log analysis system 1 according to the first example embodiment illustrated in FIG. 3. In this case, the CPU 2002 executes a program that implements the functions of the variable pattern acquisition unit 116 and the variable separation unit 118.

Further, the variable pattern acquisition unit 116 and the variable separation unit 118 may also be implemented by electronic circuitry, respectively.

As illustrated in the present example embodiment, a variable pattern can be used to acquire a log pattern and acquire a variable value list.

### Third Example Embodiment

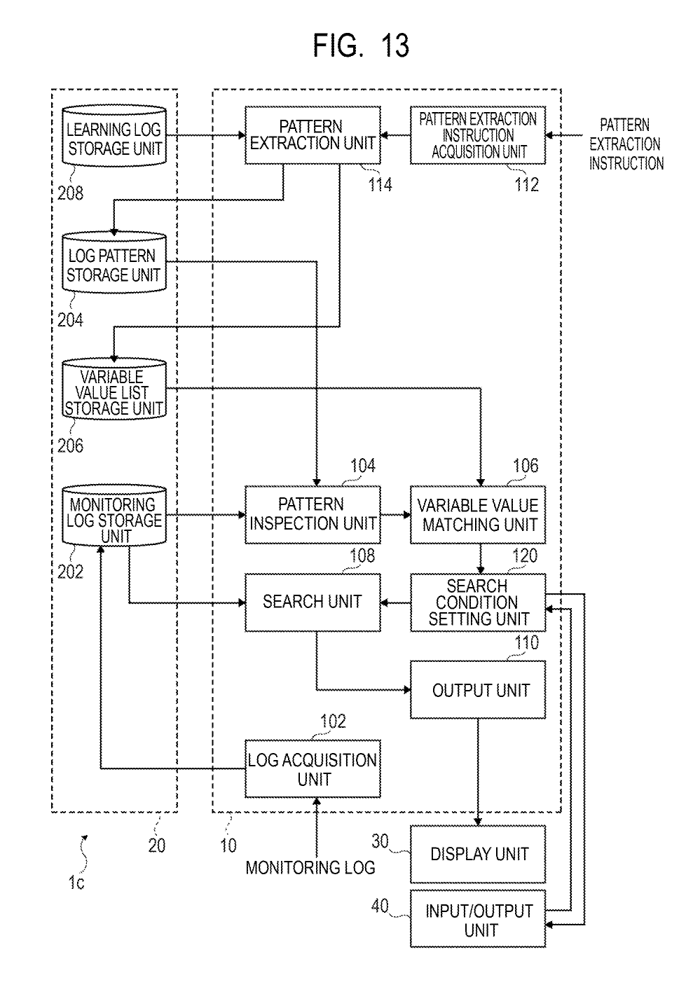

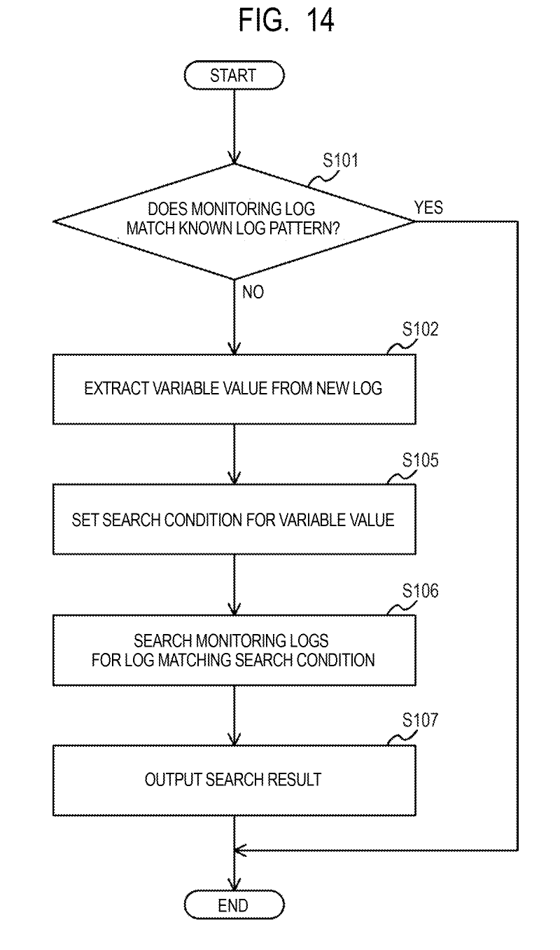

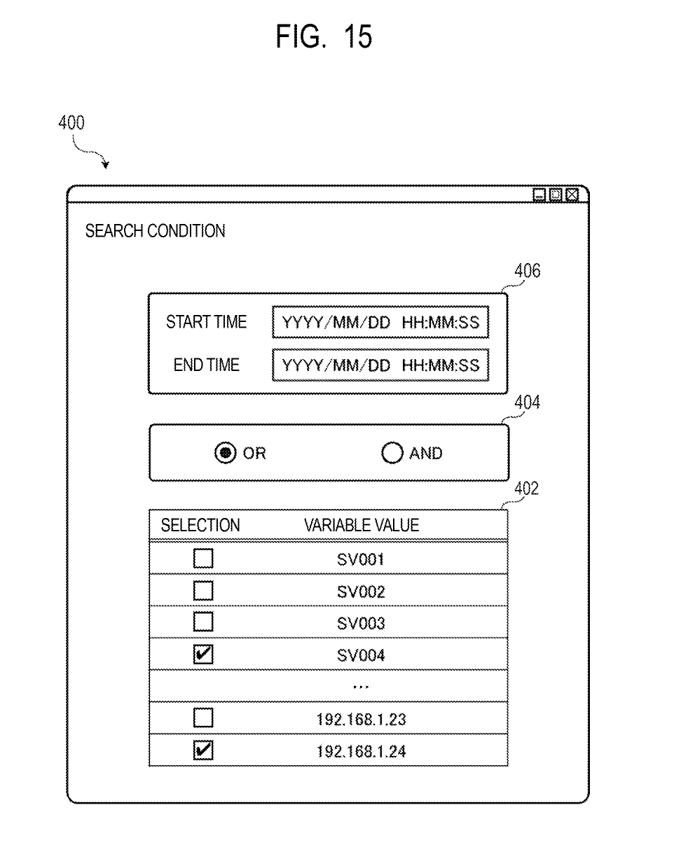

A log analysis system and a log analysis method according to a third example embodiment of the present invention will be described by using FIG. 13 to FIG. 15. FIG. 13 is a block diagram illustrating a functional configuration of the log analysis system according to the present example embodiment. FIG. 14 is a flowchart illustrating the log analysis method using the log analysis system according to the present example embodiment. FIG. 15 is a diagram illustrating a search condition setting window in the log analysis system according to the present example embodiment. Note that components similar to the log analysis system and the log analysis method according to the first and second example embodiments described above are labeled with the same reference symbol, and the description thereof will be omitted or simplified.

In the log analysis system 1 according to the first example embodiment described above, the search unit 108 searches for a log including a variable value extracted from a new log by the variable value matching unit 106. In contrast, the log analysis system according to the present example embodiment is different from the log analysis system 1 according to the first example embodiment in that search conditions can be set in searching by the search unit 108.

As illustrated in FIG. 13, the log analysis system 1c according to the present example embodiment further has a search condition setting unit 120 that enables setting of search conditions in searching by the search unit 108, in addition to the functional configuration of the log analysis system 1 according to the first example embodiment illustrated in FIG. 2.

The search condition setting unit 120 presents a variable value extracted from a new log by the variable value matching unit 106 to an operator, which is a user of the log analysis system 1c according to the present example embodiment, via an input/output unit 40. The operator to which a variable value is presented by the search condition setting unit 120 can set a search condition including a search condition regarding a variable value and input the search condition to the search condition setting unit 120 via the input/output unit 40.

Once a search condition is input by the operator, the search condition setting unit 120 sets the input search condition in the search unit 108. The search unit 108 searches monitoring logs stored in the monitoring log storage unit 202 for a log which matches the search condition set by the search condition setting unit 120.

Note that the log analysis system 1c according to the present example embodiment may also have the same hardware configuration as that of the log analysis system 1 according to the first example embodiment illustrated in FIG. 3. In this case, the CPU 2002 executes a program that implements the function of the search condition setting unit 120.

Further, the search condition setting unit 120 may also be implemented by electric circuitry.

The log analysis method using the log analysis system 1c according to the present example embodiment will be described below.

First, as illustrated in FIG. 14, in the same manner as the first example embodiment, the pattern inspection unit 104 inspects whether or not each of the monitoring logs stored in the monitoring log storage unit 202 matches a known log pattern (step S101).

If the monitoring log matches a known log pattern (step S101, YES), the process ends in the same manner as the first example embodiment.

On the other hand, if the monitoring log does not match any of the known log patterns (step S101, NO), the variable value matching unit 106 extracts a variable value from a new log that does not match any of the known log patterns in the same manner as the first example embodiment (step S102).

Next, the search condition setting unit 120 presents the variable value extracted from the new log by the variable value matching unit 106 to the operator via the input/output unit 40. In response to the variable value being presented by the search condition setting unit 120, the operator sets a search condition including a search condition regarding a variable value and inputs the search condition to the search condition setting unit 120 via the input/output unit 40. Once the search condition is input by the operator, the search condition setting unit 120 sets the input search condition in the search unit 108 (step S105).

FIG. 15 illustrates an example of a search condition setting window by which the operator sets a search condition. A search condition setting window 400 illustrated in FIG. 15 is displayed on the input/output unit 40 by the search condition setting unit 120. The search condition setting window 400 has a variable value selection field 402, an AND/OR search setting field 404, and a time range setting field 406.

In the variable value selection field 402, the variable value extracted from a new log by the variable value matching unit 106 is displayed in a selectable manner by the search condition setting unit 120. In the variable value selection field 402, it is possible to select one or more variable values used for searching by checking the corresponding check box, for example.

The AND/OR search setting field 404 is used for setting whether to perform AND search or perform OR search. In the AND/OR search setting field 404, it is possible to select and set AND search or OR search by using a radio button, for example. When AND search is selected, AND search that searches a log including all the variable values selected in the variable value selection field 402 is set. On the other hand, when OR search is selected, OR search that searches a log including any of the variable values selected in the variable value selection field 402 is set.

The time range setting field 406 is used for setting the time range of a log to be searched. In the time range setting field 406, it is possible to set the start time and the end time of a time range of a log to be searched.

While OR search that searches a log including any of all the variable values included in a new log is performed in the first example embodiment described above, a particular variable value which is apparently unrelated to an anomaly can be removed from the search condition. For example, in the search condition setting window 400 illustrated in FIG. 15, “SV001”, “SV002”, “SV003”, and “192.168.1.23” of the extracted variable values are removed from the search condition.

After a search condition is set, the search unit 108 searches the monitoring logs stored in the monitoring log storage unit 202 for a log which matches the search condition set by the search condition setting unit 120 (step S106).

Note that it is also possible to loop back to step S105 in response to a search result obtained by the search unit 108 to reset a search condition by the search condition setting unit 120 and again perform searching by the search unit 108 with the reset search condition.

Further, as described in the first example embodiment, also in a log searched in searching performed by the search unit 108 for a log including a variable value included in a new log, information which could cause an anomaly may appear as a variable value in the log. The search condition setting unit 120 can also add, to the search condition, such a variable value included in a log searched in searching for a log including a variable value included in a new low. The search unit 108 can again perform searching with such a search condition.

Next, in the same manner as the first example embodiment, the output unit 110 outputs the search results obtained by the search unit 108 to the display unit 30 for display on the display unit 30 (step S107).

As discussed above, according to the present example embodiment, since a search condition can be set by the search condition setting unit 120, the operator can perform searching by the search unit 108 by setting a search condition based on knowledge obtained in advance, the search result, or the like. Therefore, according to the present example embodiment, the cause which leads to an anomaly indicated in a new log can be efficiently identified.

Note that, while the case where the search condition setting unit 120 is further provided in addition to the functional configuration of the log analysis system 1 according to the first example embodiment illustrated in FIG. 2 has been described above, the example embodiment is not limited thereto. The search condition setting unit 120 may be further provided in addition to the functional configuration of the log analysis system 1b according to the second example embodiment illustrated in FIG. 12.

### Fourth Example Embodiment

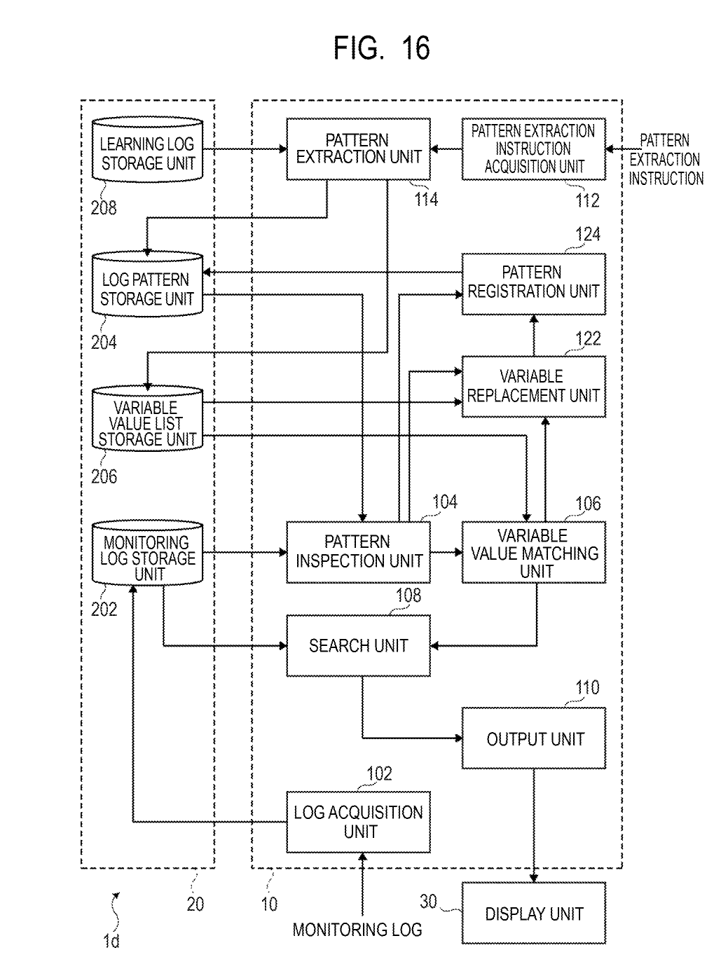

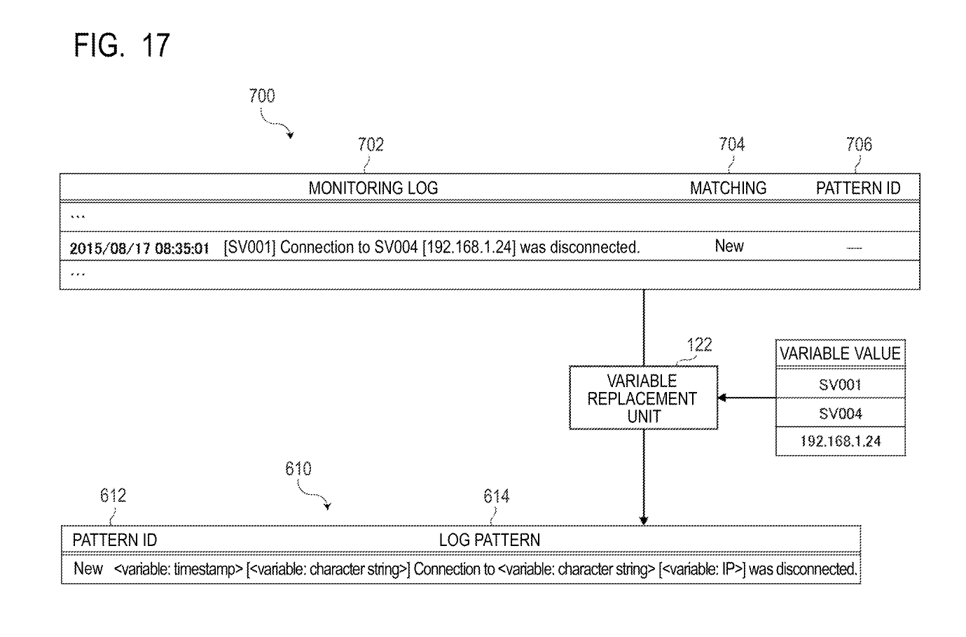

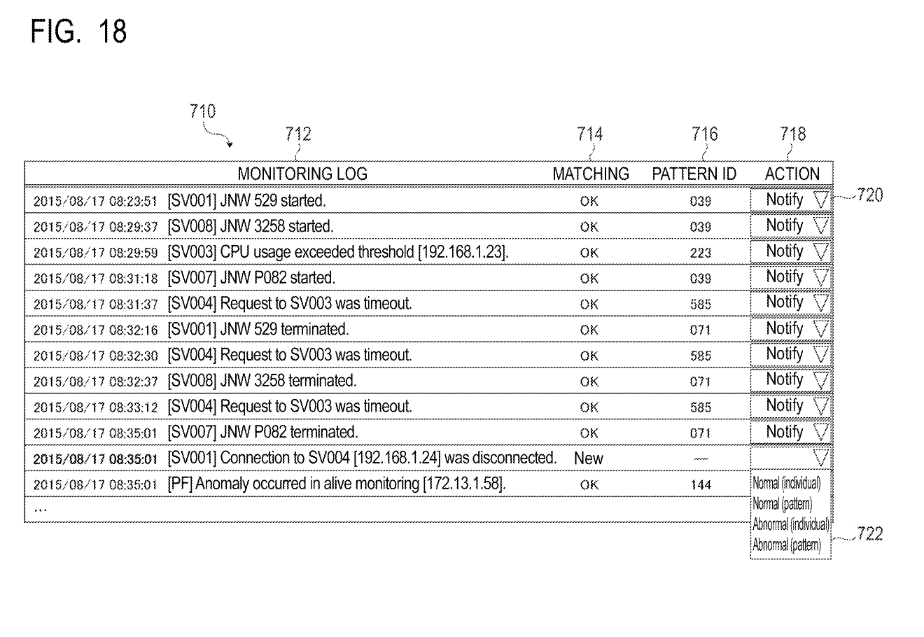

A log analysis system and a log analysis method according to a fourth example embodiment of the present invention will be described by using FIG. 16 to FIG. 18. FIG. 16 is a block diagram illustrating a functional configuration of the log analysis system according to the present example embodiment. FIG. 17 is a diagram illustrating extraction of a log pattern by a variable replacement unit in the log analysis system according to the present example embodiment. FIG. 18 is a diagram illustrating an example of a registration window used for registering a log pattern in the log analysis system according to the present example embodiment. Note that components similar to the log analysis system and the log analysis method according to the first to third example embodiments described above are labeled with the same reference symbol, and the description thereof will be omitted or simplified.

The log analysis system according to the present example embodiment is different from the log analysis system 1 according to the first example embodiment in that it is possible to register whether a new log detected by the pattern inspection unit 104 is normal or abnormal.

As illustrated in FIG. 16, a log analysis system 1d according to the present example embodiment further has a variable replacement unit 122 and a pattern registration unit 124 in addition to the functional configuration of the log analysis system 1 according to the first example embodiment illustrated in FIG. 2.

The variable replacement unit 122 functions as a format extraction unit, which identifies a part in which a variable value appears in a new log detected by the pattern inspection unit 104 and replaces the part with a variable to extract a log pattern from the new log. In extraction of a log pattern, the variable replacement unit 122 references a variable value extracted from a new log by the variable value matching unit 106 and replaces a part in which the variable value appears in the new log with a variable.

FIG. 17 is a diagram illustrating extraction of a log pattern performed by the variable replacement unit 122. FIG. 17 illustrates a case where a log pattern is extracted from the monitoring log detected as a new log in FIG. 7 described above.

As illustrated in FIG. 17, the variable replacement unit 122 references “SV001”, “SV004”, and “192.168.1.24” that are variable values extracted by the variable value matching unit 106. These variable values are extracted from the new log recorded in the record of the table 700. The variable replacement unit 122 identifies a part in which a variable value appears in the new log recorded in the record of the table 700 and replaces the part with a variable based on the referenced variable value.

The variable replacement unit 122 records the extracted log pattern in a table 610. Note that the table 610 is prepared for each normal log pattern and each abnormal log pattern described later and stored in the log pattern storage unit 204. Each record recorded in the table 610 has a pattern ID item 612 and a log pattern item 614. In the pattern ID item 612, pattern IDs used for identifying the extracted log pattern are recorded. In FIG. 17, “New” is displayed in the pattern ID item 612, and a new pattern ID that is unique to the extracted log pattern is recorded in this item. In the log pattern item 614, the extracted log pattern is recorded.

The pattern registration unit 124 stores a log pattern based on a new log detected by the pattern inspection unit 104 in the log pattern storage unit 204 and registers the log pattern as a normal log pattern or an abnormal log pattern.

Specifically, the pattern registration unit 124 stores, in the log pattern storage unit 204, a log pattern extracted from a new log by the variable replacement unit 122. In storing a log pattern in the log pattern storage unit 204, the pattern registration unit 124 resisters the log pattern as a normal log pattern or an abnormal log pattern.

Further, the pattern registration unit 124 stores, in the log pattern storage unit 204, a new log detected by the pattern inspection unit 104 as a log pattern as it exists. Note that, even when a new log is stored as a log pattern as it exists, a timestamp can be handled as a variable. That is, a log which is different in only the timestamp from a new log as a log pattern is handled assuming that the log matches the new log as a log pattern. In storing a new log as a log pattern in the log pattern storage unit 204, the pattern registration unit 124 registers the log pattern as a normal log pattern or an abnormal log pattern.

Whether or not to store a log pattern in the log pattern storage unit 204 by the pattern registration unit 124 for registration can be selected by the operator as described later. Further, whether or not a log pattern is a normal log pattern or an abnormal log pattern can be determined by the operator as described later.

Note that the log analysis system 1d according to the present example embodiment may also have the same hardware configuration as the log analysis system 1 according to the first example embodiment illustrated in FIG. 3. In this case, the CPU 2002 executes a program that implements the functions of the variable replacement unit 122 and the pattern registration unit 124.

Further, the variable replacement unit 122 and the pattern registration unit 124 may also be implemented by electronic circuitry, respectively.

In the present example embodiment, in inspecting whether or not a monitoring log matches a known log pattern, the pattern inspection unit 104 also references log patterns stored in the log pattern storage unit 204 by the pattern registration unit 124. The pattern inspection unit 104 then inspects whether or not a monitoring log matches a normal log pattern or an abnormal log pattern registered by the pattern registration unit 124. When the monitoring log matches an abnormal log pattern, the pattern inspection unit 104 can notify the operator of the detection of a log which matches an abnormal log pattern, that is, a log indicating an abnormal via the display unit 30 or the like.

FIG. 18 is a diagram illustrating an example of a registration window used for registering a log pattern. A registration window 710 illustrated in FIG. 18 displays the table 700 that records results of inspection performed by the pattern inspection unit 104 illustrated in FIG. 7 described above and displays a predetermined action for each monitoring log in a selectable manner.

Each record displayed in the registration window 710 has a monitoring log item 712, a matching item 714, and a pattern ID item 716. In the monitoring log item 712, the inspected monitoring logs are displayed. In the matching item 714, inspection results are displayed. The matching item 714 of “OK” indicates that the monitoring log matches a known log pattern, the matching item 714 of “New” indicates that the monitoring log is a new one that does not match any known log pattern. In the pattern ID item 716, a pattern ID of a log pattern matched by a monitoring log when the monitoring log matches a known log pattern is displayed.

Furthermore, each record displayed in the registration window 710 has an action item 718. In each action item 718, a pulldown menu in accordance with a search result displayed in the matching item 714 is displayed.

Specifically, in the action item 718 in a record in which the matching item 714 is “OK”, a notification necessary/unnecessary setting pulldown menu 720 is displayed. The notification necessary/unnecessary setting pulldown menu 720 will be described below in the fifth example embodiment.

On the other hand, in the action item 718 in a record in which the matching item 714 is “New”, a normal/abnormal registering pulldown menu 722 is displayed. The normal/abnormal registering pulldown menu 722 enables the operator to select any of the items; “Normal (individual)”, “Normal (pattern)”, “Abnormal (individual)”, and “Abnormal (pattern)”.

When “Normal (individual)” is selected in the normal/abnormal registering pulldown menu 722, the new log displayed in the record is registered as a normal log pattern as it exists by the pattern registration unit 124 as described above. Further, when “Normal (pattern)” is selected, the log pattern extracted by the variable replacement unit 122 from the new log displayed in the record is registered as a normal log pattern by the pattern registration unit 124 as described above.

On the other hand, when “Abnormal (individual)” is selected in the normal/abnormal registering pulldown menu 722, the new log displayed in the record is registered as an abnormal log pattern as it exists by the pattern registration unit 124 as described above. Further, when “Abnormal (pattern)” is selected, the log pattern extracted by the variable replacement unit 122 from the new log displayed in the record is registered as an abnormal log pattern by the pattern registration unit 124 as described above.

Note that, while the case where the variable replacement unit 122 and the pattern registration unit 124 are further provided in addition to the functional configuration of the log analysis system 1 according to the first example embodiment illustrated in FIG. 2 has been described above, the example embodiment is not limited thereto. The variable replacement unit 122 and the pattern registration unit 124 may be further provided in addition to the functional configurations of the log analysis systems 1b and 1c of the second and third example embodiments illustrated in FIG. 12 and FIG. 13.

### Fifth Example Embodiment

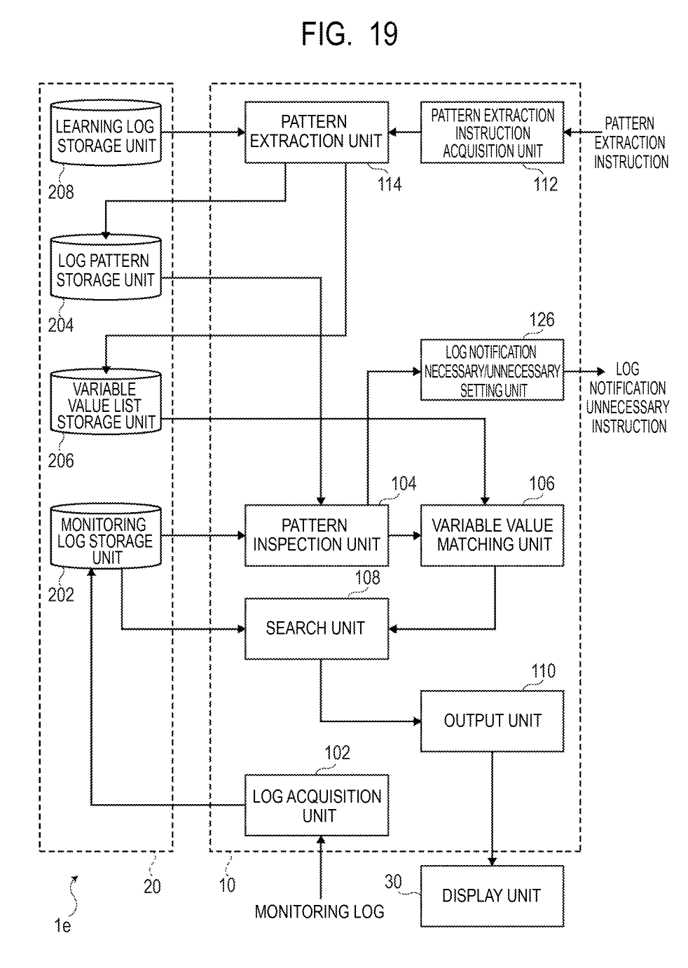

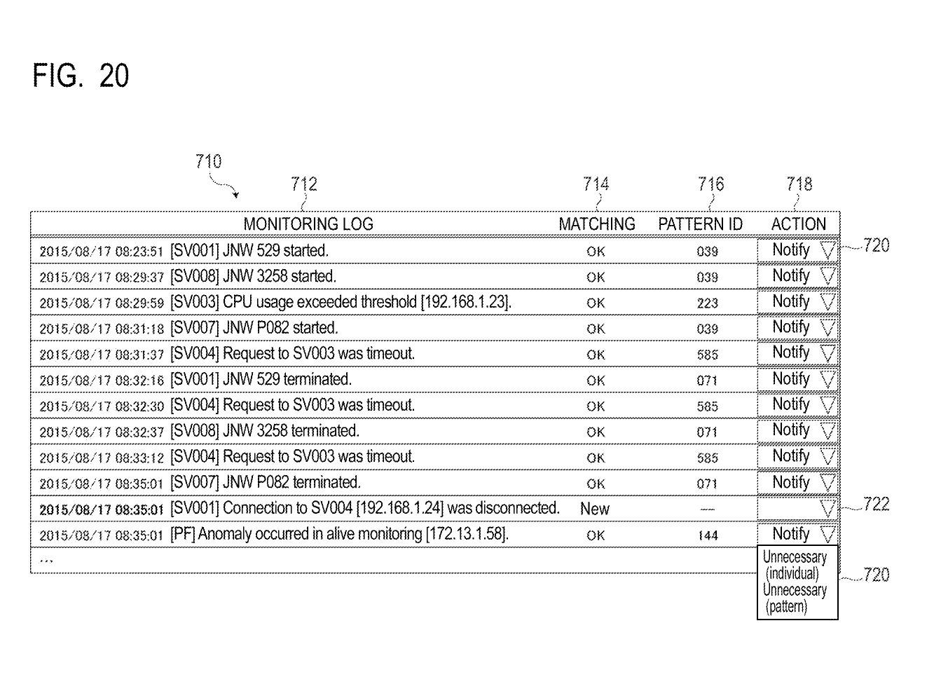

A log analysis system and a log analysis method according to a fifth example embodiment of the present invention will be described by using FIG. 19 and FIG. 20. FIG. 19 is a block diagram illustrating a functional configuration of the log analysis system according to the present example embodiment. FIG. 20 is a diagram illustrating an example of a setting window used for setting whether or not a log notification is necessary in the log analysis system according to the present example embodiment. Note that components similar to the log analysis system and the log analysis method according to the first to fourth example embodiments described above are labeled with the same reference symbol, and the description thereof will be omitted or simplified.

The log analysis system according to the present example embodiment is different from the log analysis system 1 according to the first example embodiment in that it is possible to set whether or not it is necessary to notify the log analysis system of a monitoring log inspected by the pattern inspection unit 104.

As illustrated in FIG. 19, a log analysis system le according to the present example embodiment further has a log notification necessary/unnecessary setting unit 126 in addition to the functional configuration of the log analysis system 1 according to the first example embodiment illustrated in FIG. 2.

The log notification necessary/unnecessary setting unit 126 is used for setting whether or not a notification to the log analysis system 1e is necessary for each of the monitoring logs inspected by the pattern inspection unit 104 as to whether or not to match a known log pattern.

Specifically, the log notification necessary/unnecessary unit 126 can apply such a setting that no notification from the monitored system 2 is made for a log, out of the monitoring logs inspected by the pattern inspection unit 104, which matches a log pattern of a log which does not require a notification.

Further, the log notification necessary/unnecessary unit 126 can apply such a setting that no notification from the monitored system 2 is made for a log, out of the monitoring logs inspected by the pattern inspection unit 104, whose part other than a timestamp matches a log which does not require a notification.

The log notification necessary/unnecessary setting unit 126 transmits a log notification unnecessary instruction via the network 3 to the monitored system 2 which has generated and output a monitoring log which does not require a notification. The log notification unnecessary instruction instructs not to notify the monitored system 2 of a log which matches a log pattern of a log which does not require notification or a log whose part other than a timestamp matches a log which does not require a notification, out of the monitoring logs.

In the monitored system 2 that has received a log notification unnecessary instruction, the setting of a log notification agent thereof is changed. This causes the monitored system 2 not to notify the log analysis system 1e of a log which does not require a notification or a log whose part other than a timestamp matches a log which does not require a notification, out of the monitoring logs.

Further, the log notification necessary/unnecessary setting unit 126 may be configured to delete a log, out of monitoring logs inspected by the pattern inspection unit 104, which does not require a notification from the monitoring log storage unit 202.

Whether or not the log notification described above is necessary can be selected and set by the operator as described above.

Note that the log analysis system 1e according to the present example embodiment may also have the same hardware configuration as that of the log analysis system 1 according to the first example embodiment illustrated in FIG. 3. In this case, the CPU 2002 executes a program that implements the function of the log notification necessary/unnecessary setting unit 126.

Further, the log notification necessary/unnecessary setting unit 126 may also be implemented by electric circuitry.

FIG. 20 is a diagram illustrating an example of a setting window used for setting whether or not a log notification is necessary. A setting window 730 illustrated in FIG. 20 is the same window as the registration window 710 illustrated in FIG. 18 described above. Each record displayed in the setting window 730 has the monitoring log item 712, the mating item 714, the pattern ID item 716, and the action item 718 in the same manner as the registration window 710 illustrated in FIG. 18 described above.

In the action item 718 in a record in which the matching item 714 is “OK”, the notification necessary/unnecessary setting pulldown menu 720 is displayed as described above. The notification necessary/unnecessary pulldown menu 720 enables the operator to select any of the items; “Notify”, “Unnecessary (individual)”, and “Unnecessary (pattern)”. In the initial state, “Notify” is selected.

When “Notify” is selected in the notification necessary/unnecessary setting pulldown menu 720, a log which matches a log pattern displayed in the record and a log whose part other than a timestamp matches the log are notified to the log analysis system 1e as usual.

On the other hand, when “Unnecessary (individual)” is selected in the notification necessary/unnecessary setting pulldown menu 720, the log notification necessary/unnecessary setting unit 126 applies such a setting that no notification is made for a log whose part other than a timestamp matches a log displayed in the record. Further, when “Unnecessary (pattern)” is selected, the log notification necessary/unnecessary setting unit 126 applies such a setting that no notification is made for a log pattern extracted by the variable replacement unit 122 from a log which matches a log pattern of a log displayed in the record. For example, in the case illustrated in FIG. 20, when “Unnecessary (pattern)” is selected, such a setting is applied that no notification is made for a log which matches a log pattern whose pattern ID is 144 (see FIG. 6).

As discussed above, in the present example embodiment, such a setting that no unnecessary log is notified from the monitored system 2 to the log analysis system 1e allows for a reduction in the data amount required to log analysis performed by the log analysis system 1e and for an efficient identification of the cause which leads to an anomaly.

Note that, while the case where the log notification necessary/unnecessary setting unit 126 is further provided in addition to the functional configuration of the log analysis system 1 according to the first example embodiment illustrated in FIG. 2 has been described above, the example embodiment is not limited thereto. The log notification necessary/unnecessary setting unit 126 may be further provided in addition to the functional configurations of the log analysis systems 1b, 1c, and 1d of the second, third, and fourth example embodiments illustrated in FIG. 12, FIG. 13, and FIG. 16.

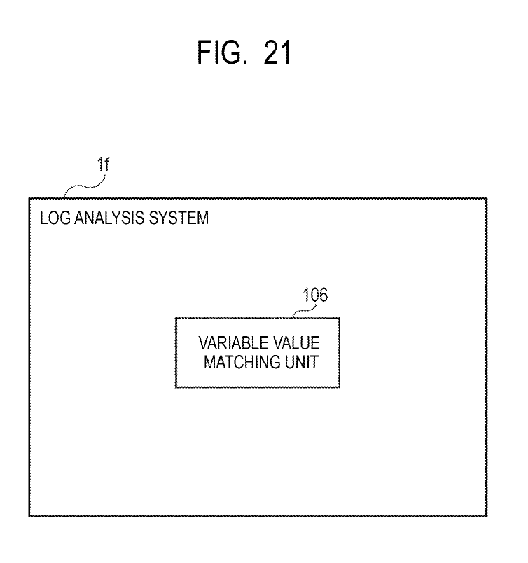

The log analysis system described in each of the above example embodiments can be configured as illustrated in FIG. 21 according to another example embodiment.

FIG. 21 is a block diagram illustrating the functional configuration of a log analysis system according to another example embodiment. A log analysis system if has a variable value matching unit 106 that functions as a variable extraction unit that, from a log which does not match a log pattern whose format is stored in a storage medium out of the monitoring logs, extracts the value of a variable included in the log.

### Modified Example Embodiment

The present invention is not limited to the example embodiments described above, and various modifications are possible.

For example, while the case where searched logs are indicated in the log lists that display search results obtained by the search unit 108, respectively, has been described in the above example embodiments, the form of displaying search results is not limited thereto. For example, logs having the same part other than the timestamp may be collectively displayed. Fig. illustrates a log list 1014 that collectively displays logs having the same part other than the timestamp instead of the log list 1004 illustrated in FIG. 10. In the log list 1014, the number of logs having the same part other than the timestamp is displayed in numbers. In the log list 1014, from the display in which logs having the same part other than the timestamp are collectively displayed, the logs having the same part other than the timestamp may be developed and displayed as illustrated in the log list 1004 illustrated in FIG. 10. In the log list 1014, enable or disable of such log development is indicated by “+” and “−”, respectively.

Further, while the case where a log including a variable value included in a new log detected by the pattern inspection unit 104 is searched by the search unit 108 has been exemplified in the above example embodiments, searching by the search unit 108 is not limited thereto. For example, the searching unit 108 may search the monitoring logs for a log including a variable value included in a log including a rare variable value, a frequently generated log, a log including content indicating an anomaly such as “Critical” or “Error”, or the like.

Further, the scope of each of the example embodiments includes a processing method that stores, in a storage medium, a program causing the configuration of each of the example embodiments to operate so as to realize the function of each of the example embodiment described above, reads a program stored in the storage medium as a code, and executes the program in a computer. That is, the scope of each of the example embodiments includes a computer readable storage medium. Further, each of the example embodiments includes not only the storage medium in which the computer program described above is stored but also the computer program itself.

As the storage medium, for example, a floppy (registered trademark) disk, a hard disk, an optical disk, a magneto-optical disk, a Compact Disc-Read Only memory (CD-ROM), a magnetic tape, a nonvolatile memory card, or a ROM can be used. Further, the scope of each of the example embodiments includes an example that operates on Operating System (OS) to perform a process in cooperation with another software or a function of an add-in board without being limited to an example that performs a process by an individual program stored in the storage medium.

A service realized by the function of each of the example embodiments described above can be provided to a user in a form of Software as a Service (SaaS).

The whole or part of the example embodiments disclosed above can be described as, but not limited to, the following supplementary notes.

### Supplementary Note 1

A log analysis system comprising a variable extraction unit that extracts, from a first log out of monitoring logs which does not match a format stored in a storage medium, a value of a variable included in the first log.

### Supplementary Note 2

The log analysis system according to supplementary note 1 further comprising a log output unit that outputs a second log out of the monitoring logs which includes the value of the variable.

### Supplementary Note 3

The log analysis system according to supplementary note 2, wherein the log output unit further outputs a third log including a value of a variable included in the second log.

### Supplementary Note 4

The log analysis system according to supplementary note 2 or 3,

wherein the log output unit is a search unit that searches the monitoring logs for the second log including the value of the variable and outputs the second log, and

the log analysis system further comprising a search condition setting unit that sets a search condition for searching performed by the search unit.

### Supplementary Note 5

The log analysis system according to any one of supplementary notes 1 to 4, wherein the format includes the variable that can vary among the monitoring logs and a common part that does not vary among the monitoring logs.

### Supplementary Note 6

The log analysis system according to any one of supplementary notes 1 to 5 further comprising a pattern inspection unit that inspects whether or not each log included in the monitoring logs matches the format and detects, as the first log, a log which does not match the format.

### Supplementary Note 7

The log analysis system according to supplementary note 6 further comprising a format extraction unit that extracts a format of the first log, wherein the pattern inspection unit further inspects whether or not each log included in the monitoring logs matches a format of the first log extracted by the format extraction unit.

### Supplementary Note 8

The log analysis system according to supplementary note 6 or 7 further comprising a notification necessary/unnecessary setting unit that provides a setting such that a log which matches a format of a predetermined log out of the monitoring logs inspected by the pattern inspection unit is not notified as the monitoring logs.

### Supplementary Note 9

A log analysis method comprising extracting, from a first log out of monitoring logs which does not match a format stored in a storage medium, a value of a variable included in the first log.

### Supplementary Note 10

The log analysis method according to supplementary note 9 further comprising outputting a second log out of the monitoring logs which includes the value of the variable.

### Supplementary Note 11

A storage medium storing a program that causes a computer to perform extracting, from a first log out of monitoring logs which does not match a format stored in a storage medium, a value of a variable included in the first log.

### Supplementary Note 12

The storage medium according to supplementary note 11, wherein the program causes the computer to further perform outputting a second log out of the monitoring logs which includes the value of the variable.

While the present invention has been described above with reference to the example embodiments, the present invention is not limited to the example embodiments described above. Various changes that can be appreciated by those skilled in the art within the scope of the present invention may be applied to the configuration or the details of the present invention.

This application is based upon and claims the benefit of priority from Japanese Patent Application No. 2015-223052, filed on Nov. 13, 2015, the disclosure of which is incorporated herein in its entirety by reference.

### REFERENCE SIGNS LIST

1, 1b, 1c, 1d, 1e, 1f log analysis system
2 monitored system
10 processing unit
20 storage unit
104 pattern inspection unit
106 variable value matching unit
108 search unit
120 search condition setting unit
122 variable replacement unit
126 log notification necessary/unnecessary setting unit

1. A log analysis system comprising a variable extraction unit that extracts, from a first log out of monitoring logs which does not match a format stored in a storage medium, a value of a variable included in the first log.

2. The log analysis system according to claim 1 further comprising a log output unit that outputs a second log out of the monitoring logs which includes the value of the variable.

3. The log analysis system according to claim 2, wherein the log output unit further outputs a third log including a value of a variable included in the second log.

4. The log analysis system according to claim 2,
wherein the log output unit is a search unit that searches the monitoring logs for the second log including the value of the variable and outputs the second log, and
the log analysis system further comprising a search condition setting unit that sets a search condition for searching performed by the search unit.

5. The log analysis system according to claim 1, wherein the format includes the variable that can vary among the monitoring logs and a common part that does not vary among the monitoring logs.

6. The log analysis system according to claim 1 further comprising a pattern inspection unit that inspects whether or not each log included in the monitoring logs matches the format and detects, as the first log, a log which does not match the format.

7. The log analysis system according to claim 6 further comprising a format extraction unit that extracts a format of the first log,
wherein the pattern inspection unit further inspects whether or not each log included in the monitoring logs matches a format of the first log extracted by the format extraction unit.

8. The log analysis system according to claim 6 further comprising a notification necessary/unnecessary setting unit that provides a setting such that a log which matches a format of a predetermined log out of the monitoring logs inspected by the pattern inspection unit is not notified as the monitoring logs.

9. A log analysis method comprising extracting, from a first log out of monitoring logs which does not match a format stored in a storage medium, a value of a variable included in the first log.

10. The log analysis method according to claim 9 further comprising outputting a second log out of the monitoring logs which includes the value of the variable.

11. A non-transitory storage medium storing a program that causes a computer to perform extracting, from a first log out of monitoring logs which does not match a format stored in a storage medium, a value of a variable included in the first log.

12. The non-transitory storage medium according to claim 11, wherein the program causes the computer to further perform outputting a second log out of the monitoring logs which includes the value of the variable.
